(19) United States
(12) Patent Application Publication
(10) Pub. No.: US 2024/0196862 A1
(43) Pub. Date: Jun. 20, 2024

(54) PORTABLE WASTE COLLECTION DEVICE

(71) Applicant: Eric Masters, Odessa, FL (US)

(72) Inventor: Eric Masters, Odessa, FL (US)

(21) Appl. No.: 18/542,935

(22) Filed: Dec. 18, 2023

Related U.S. Application Data
(60) Provisional application No. 63/433,839, filed on Dec. 20, 2022.

(51) Int. Cl. A01K 23/00

(52) U.S. Cl. CPC A01K 23/005

(57) ABSTRACT

A portable waste collection device includes waste collection section having an open end providing access into an annular inner housing configured to store and hold therein a supply of waste collection bags. The collection section has a cover for removably covering the annular inner housing from the open end, and spaced-apart inner and outer annular members forming the annular inner housing therebetween. The inner housing has a base disposed opposite the top end and forming a bottom end of the waste collection section. The inner annular member has a central passage extending through the waste collection section from the top end to the bottom end. The portable waste collection device is configured for use to collect animal or human feces by placing the collection device beneath the animal's or human's derriere during the defecation process.

### RELATED APPLICATION

The present application claims the benefit of U.S. Provisional Patent Application No. 63/433,839 filed on Dec. 20, 2022.

### BACKGROUND

### Technical Field

The present invention relates generally to sanitary receptacles and, more particularly, to a portable waste collection device for collecting waste. More specifically, the portable waste collection device is configured for use to collect animal or human feces by placing the collection device beneath the animal's or human's derriere during the defecation process.

### Background Information

Prompt waste cleanup is essential to the good health of a pet and family. Pet waste creates unpleasant odors and can damage landscaping and flora. Pet waste also has been known to carry diseases and to promote the activities of disease-carrying insects. In this regard, disposal of pet stools regularly protects against disease-causing bacteria, hookworms, whipworms, and other organisms that could cause serious illness.

Dogs tend to excrete while they are being walked. Once the droppings fall on the ground or grass, it is difficult to collect them completely. This is especially difficult when the dog stool is loose or watery, making the cleaning process a hassle for the dog walker. Additionally, dog feces contain a number of bacteria that can kill parts of the owner's lawn or be carried into the house, if they themselves or the dog happen to step in any dog waste residue.

Devices for the sanitary catching, pick-up, or scooping removal of pet waste are already well known. Most of these known devices attempt to provide for easy disposal of pet waste after it is collected from the ground. Generally, these devices are designed such that the waste is collected directly into a plastic bag, which can then be placed in an appropriate waste receptacle. While generally effective, these devices are not totally satisfactory from the viewpoint of convenience of use. Specifically, while these pet waste receptacle devices may be suitable for the purposes for which they were designed, they would not be as suitable for the purposes of the present invention, as hereinafter described.

The prior art also fails to provide any effective portable waste collection device for use to collect feces excreted by humans, such as children during the potty-training stage and elderly individuals with poor mobility.

Consequently, there is a need for a portable waste collection device which overcomes the drawbacks of the conventional art.

### SUMMARY

According to an aspect of the present invention, a portable waste collection device is provided. The collection device is designed for the direct collection and disposal of an amount of animal or human feces during the animal's or human's defecation process.

In one aspect, the present invention provides a portable waste collection device comprising a waste collection section having an open end providing access into an annular inner housing configured to store and hold therein a supply of waste collection bags. The collection section has spaced-apart inner and outer annular members forming the annular inner housing therebetween. The inner housing has a base disposed opposite the top end and forming a bottom end of the collection section. The inner annular member has a central passage extending through the waste collection section from the top end to the bottom end.

In an exemplary embodiment, the collection section is made of a single, unitary piece of material, such as a high-density polyethylene (HDPE).

According to a feature of the present invention, the collection section is in the form of a cartridge configured to store the supply of waste collection bag while permitting individual bags to be continuously pulled out from the supply and through the central passage of the inner annular member.

As another feature of the present invention, waste collection section has a cover configured for removably covering the annular inner housing from the open end of the waste collection section. The cover is further configured to securely retain the supply of waste collection bags within the annular inner housing. The cover is further configured to be readily removed from the top end of the waste collection section to allow a new supply of waste collection bags to be accommodated within the annular inner housing.

In yet another feature of the present invention, the supply of waste collection bags is provided with perforations at selected portions along the length of the supply to permit individual bags to be ripped off from the supply.

According to another feature of the present invention, the waste collection device further comprises a holding section connected to the collection section and configured to permit a user of the collection device to hold and position the waste collection section during use of the collection section to collect waste.

In still another feature of the present invention, the waste collection device further comprises an elongated telescoping handle configured for removable connection to the waste collection section.

Another feature of the portable waste collection device of the present invention includes means for varying the angle between a longitudinal extension of the handle and the waste collection section to selectively adjust the position of the waste collection section during use of the collection device.

According to another feature of the present invention, the portable waste collection device is also adapted for use to collect waste without the need for deploying a bag from the supply of waste collection bags configured to be stored in the cartridge. Instead, during each use of the waste collection device, the user can mount an individual bag on the device to collect waste using any suitable removable connecting means, such as cable ties (e.g., zip ties), rubber bands, etc.

In another aspect, the present invention provides a portable animal waste collection device comprising a waste collection section and a handle configured for removable connection to the waste collection section for placing the waste collection section beneath the derriere of an animal to collect animal feces while the animal is defecating. The waste collection section has an open-end providing access into an annular inner housing configured to store and hold therein a supply of waste collection bags, a cover for removably covering the annular inner housing from the open end and spaced-apart inner and outer annular members forming the annular inner housing therebetween. The inner housing has a base disposed opposite the top end and forming a bottom end of the waste collection section. The inner annular member has a central passage extending through waste collection section from the top end to the bottom end

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a side view of a portable waste collection device with a waste collection bag in place, in accordance with an embodiment of the present invention;

FIG. 2 is a top view of the portable waste collection device in FIG. 1;

FIG. 3 is a front view of the portable waste collection device in FIG. 1;

FIG. 4 is a perspective view of the portable waste collection device in FIG. 1;

FIG. 5 is a side view of a portable waste collection device like FIG. 1, with the collection bag removed;

FIG. 6 is a perspective view of the portable waste collection device in FIG. 5;

FIG. 7 is a top view of the portable waste collection device in FIG. 5, with the handle removed;

FIG. 8 is a perspective view of the portable waste collection device in FIG. 7;

FIG. 9 is a perspective view of the handle of the portable waste collection device shown in a fully retracted position;

FIG. 10 is a side view of the handle in FIG. 9;

FIG. 11 is a side view of the handle of the portable waste collection device shown in a fully extended position;

FIG. 12 is a perspective view of the handle in FIG. 11;

FIG. 13 is an exploded view in perspective of the portable waste collection device according to an embodiment of the present invention, including the supply of waste collection bags shown relative to the cartridge and cover of the collection section;

FIG. 14 is a side view of the portable waste collection device in FIG. 13;

FIG. 15 is an exploded view in perspective of the collection section of the portable waste collection device, showing the supply of waste collection bags stored in the inner housing of the cartridge and the cover disconnected from the cartridge; and

FIG. 16 is a perspective view of the collection section of the portable waste collection device, with the cover disconnected from the cartridge and one of the bags from the supply of waste collection bags in place and with an open end ready to be tied into a knot for use of the collection device to collect waste.

### DETAILED DESCRIPTION OF PREFERRED EMBODIMENTS

An embodiment of the present invention provides a portable waste collection device. The waste collection device is designed for the direct collection and disposal of an amount of animal or human (hereinafter also “individual”) feces during the defecation process. The portable waste collection device is configured to be handheld and carried by the user for use to collect the feces before it touches the ground.

As described herein, the term “animal” includes small household animals including, but not limited to, various type of pets, including various sizes of dogs, and the term “human” includes humans of all ages and physical conditions.

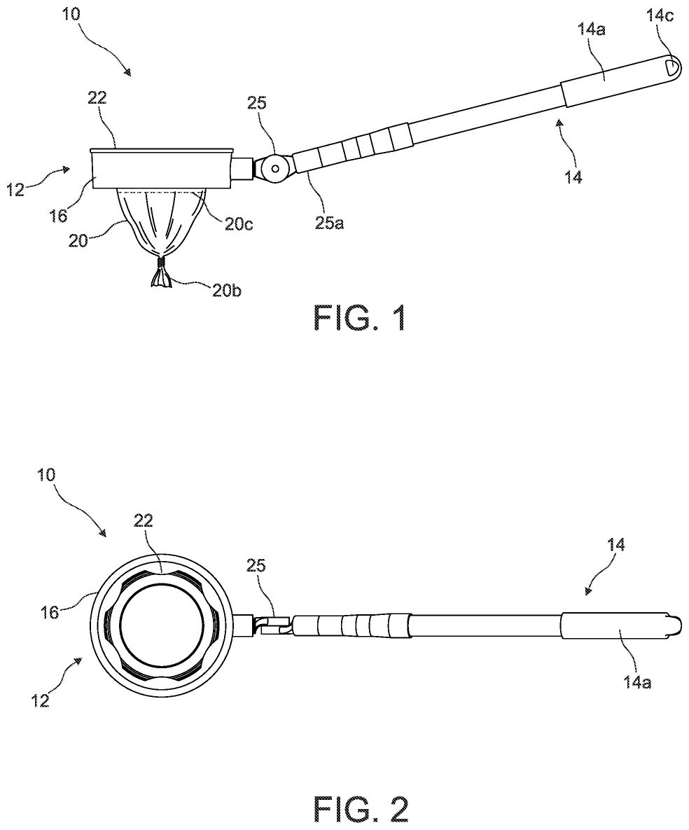

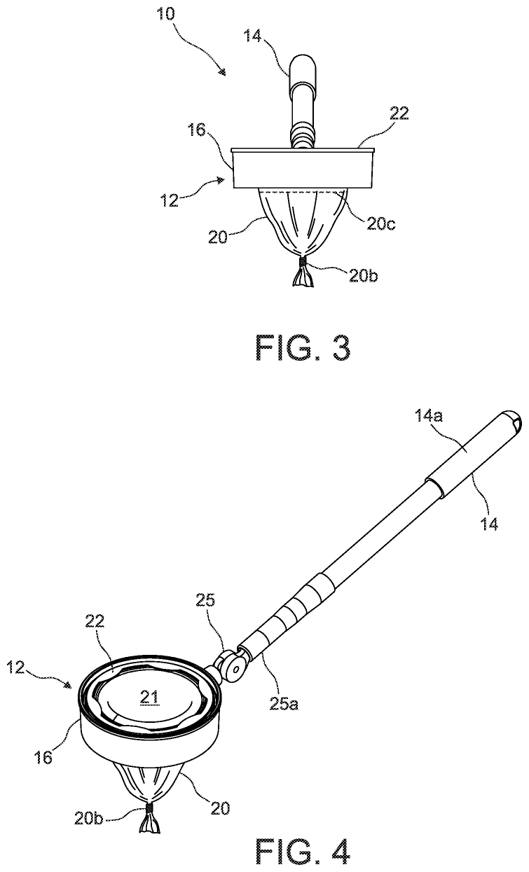

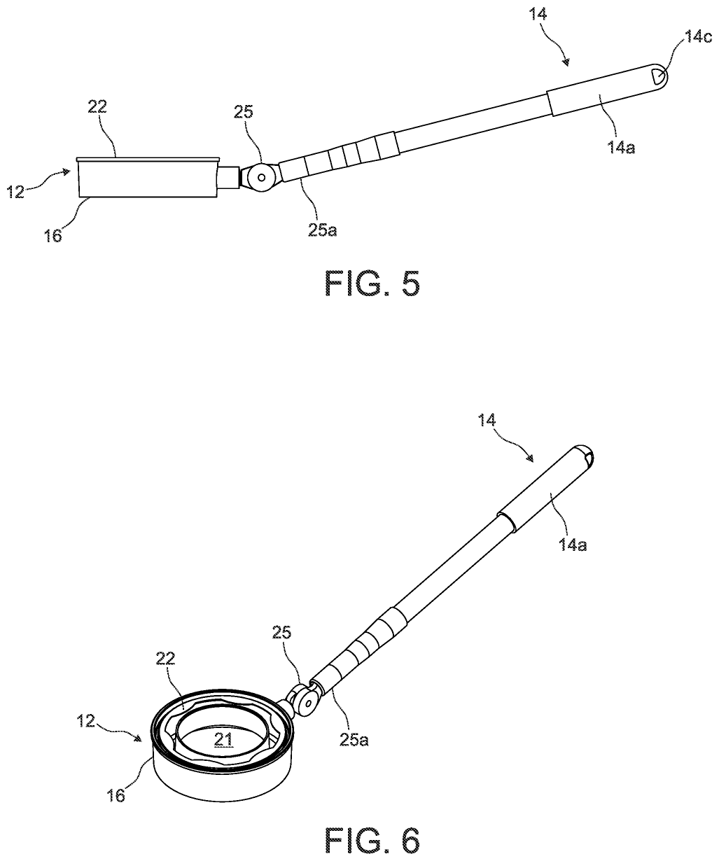

With reference now to the drawings, and in particular FIG. 1 through FIG. 16 thereof, an embodiment employing the principles and concepts of the portable waste collection device generally designated by the reference number 10 will be described. Collection device 10 includes a waste collection section 12 and an elongated telescoping handle 14 configured for removable connection to waste collection section 12.

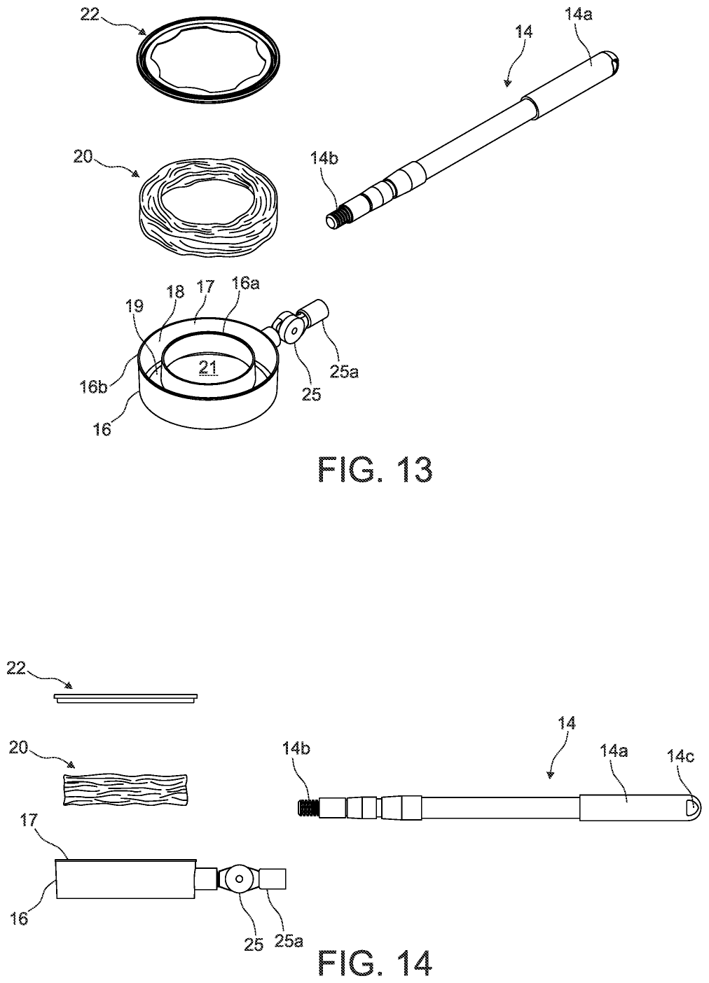

Collection section 12 includes a cartridge 16 with an open top end 17 providing access into an annular inner housing 18 configured to store and hold therein a supply of waste collection bags 20 as shown in FIGS. 13, 15 and 16. Cartridge 16 is formed with concentric and spaced-apart inner 16a and outer 16b annular members forming annular inner housing 18 therebetween. Inner housing 18 has a base 19 disposed opposite top end 17 and defining a bottom end of cartridge 16. Inner annular member 16a has a central passage 21 extending through cartridge 16 from top end 17 to bottom end 19.

Collection section 12 also includes a removable cover 22 for covering inner housing 18 from top end 17 of cartridge 16. When covering top end 17, cover 22 is configured to securely retain waste collection bags 20 within inner housing 18. Cover 22 is also configured to be removed from top end 17 to allow a new supply of waste collection bags 20 to be placed and stored within inner housing 18. Cover 22 is preferably removably connected to collection section 12 by friction fit. However, other forms of removable connection between cover 22 and collection 12 are suitable without departing from the scope of the present invention.

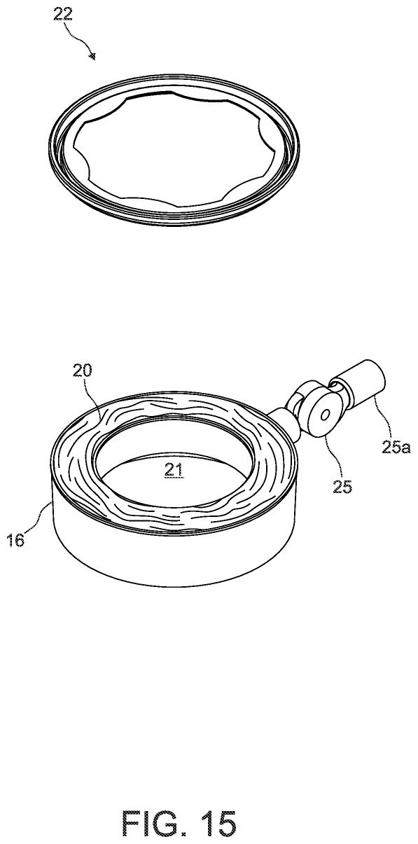

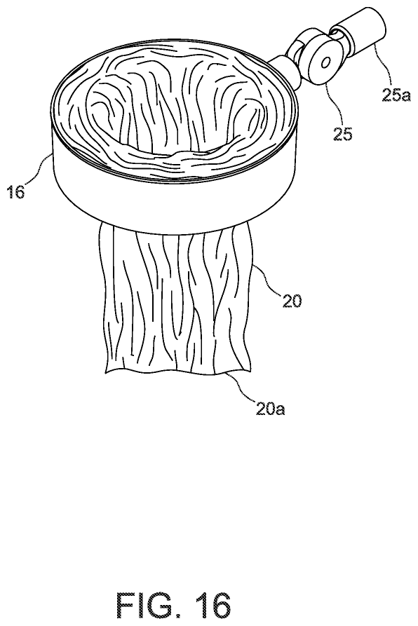

According to a feature of the present invention, when waste collection bags 20 are stored in inner housing 18, and with cover 22 removed as shown in FIG. 15, the configuration of collection section 12 permits one of the bags to be pulled out of inner housing 18 from the top end 17, over inner annular member 16a, and through central passage 21 to extend below bottom end 19 of cartridge 16, as shown in FIG. 16. Cover 22 is then attached to cartridge 16 to cover top end 17, as shown in FIGS. 1-4. Thereafter, either before or after cover 22 is attached to cartridge 16, an open end 20a of bag 20 that has been pulled out is tied into a knot 20b as shown in FIGS. 1, 3 and 4. Collection section 12 is now configured for a waste collection process in which collection section 12 is placed beneath the animal's or individual's derriere while defecating to collect the waste. This configuration of collection section 12 is shown in FIGS. 1-4, for example.

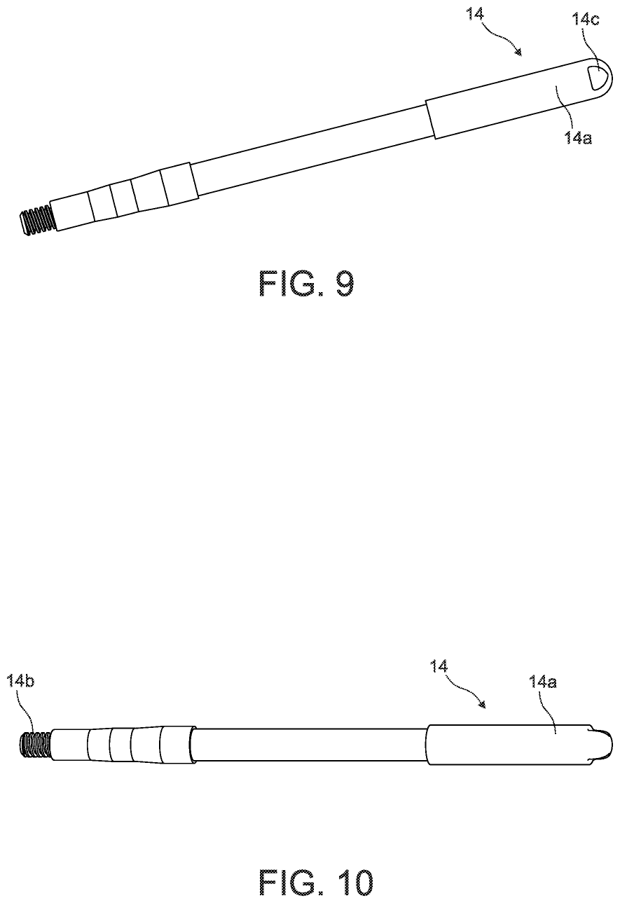

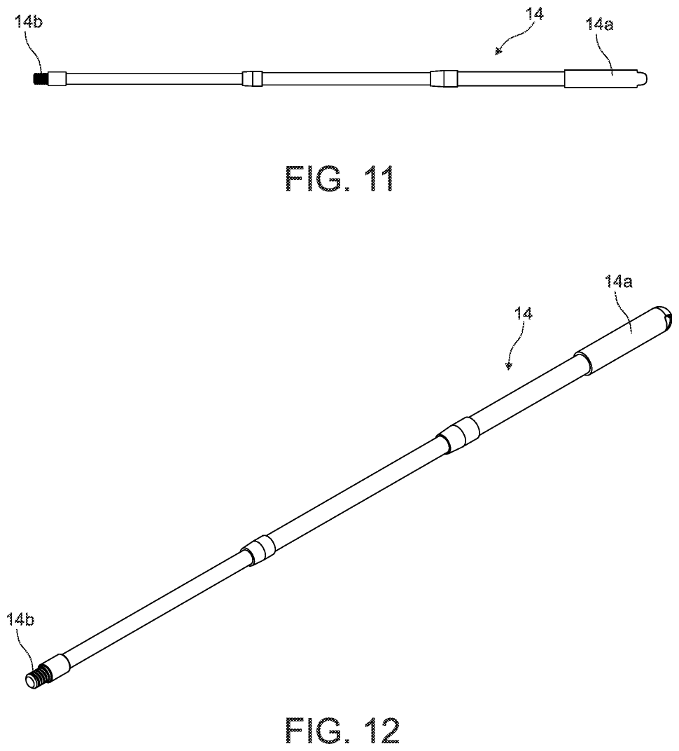

Handle 14 is a rigid, elongated handle that can be removably connected to collection section 12 to facilitate placement of collection section 12 beneath the animal's or individual's derriere while defecating. As shown in FIGS. 9-12, in the present embodiment handle 14 is of the telescoping type to permit adjustment of the handle length. FIGS. 9-10 show handle 14 in a fully retracted position, and FIGS. 11-12 show handle 14 in a fully extended position.

Handle 14 is connected to collection section 12 via a connection assembly 25 extending from a side surface of collection section 12 as shown in FIGS. 1, 2, 4-8 and 13-16. Connection assembly 25 is of the pivotal type to permit pivotal movement between collection section 12 and handle 14 to vary the angle therebetween. For this purpose, in an exemplary embodiment connection assembly 25 may be in the form of a ratchet-type pivotal connection assembly. By this construction, connection assembly 25 permits handle 14 to be angled in a suitable orientation relative to collection section 12 so that the user does not have to bend over during a waste collection process. That is, there is never any need to bend down to pick up the waste from the ground.

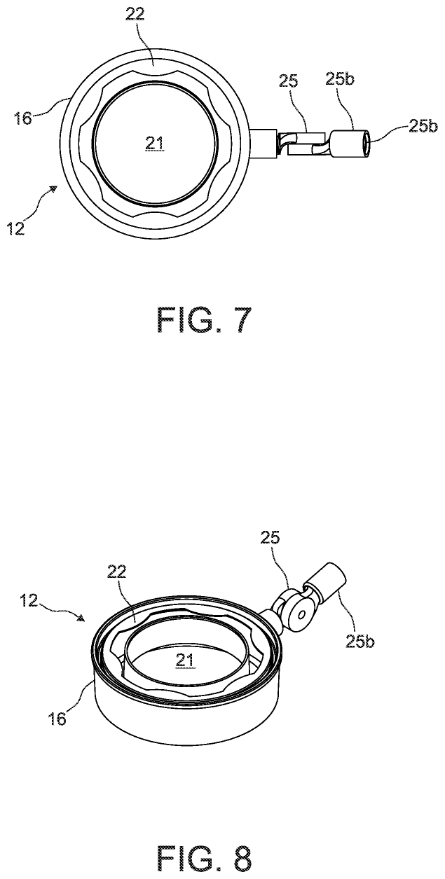

In the present embodiment, connection assembly 25 includes a tubular connector 25a with a female thread 25b as shown in FIG. 7. Handle 14 has a handle portion 14a at one end and an opposite terminal end provided with a male thread 14b configured for threaded engagement with female thread 25b of tubular connection 25a to removable connect handle 14 to collection section 12. It is understood that the foregoing connection between collection section 12 and handle 14 is not limited to a threaded engagement. Other forms of removable connections are suitable between collection section 12 and handle 14, such as friction fit connections and connections involving various types of removable fasteners. Handle portion 14a includes an eyelet 14c thereon so as to allow handle 14 to be hung from a hook or similar support.

According to a feature of the present invention, cartridge 16 is configured to function as both a means for storing a supply of waste collection bags 20 as shown in FIGS. 15-16 and a means for supporting one of the waste collection bags 20 in the state shown in FIGS. 1-4 for facilitating collection of waste when collection section 12 is placed beneath the animal's or individual's derriere while defecating. In the present embodiment, these functions are accomplished by the structural configuration of cartridge 16, including concentric and spaced-apart inner 16a and outer 16b annular members forming annular inner housing 18 therebetween and central passage 21 of inner annular member 16a as described above. Annular inner housing 18 conveniently holds and stores therein the supply of waste collection bags 20. Central passage 21 permits the bag 20 which has been pulled from the supply to be passed therethrough to achieve the configuration shown in FIG. 16, at which point open end 20a of bag 20 can be tied into a knot 20b as shown in FIGS. 1, 3, 4. In the configuration shown in FIGS. 1, 3, 4, waste collection device 10, including collection section 12, is ready for use to collect waste as described above.

After each instance that waste collection device 10 is used to collect waste, in the configuration shown in FIGS. 1, 3, 4, for example, bag 20 is pulled through central passage 21, cut, tied at the cut end (opposite the end with knot 20b), and disposed. After used bag 20 is cut, the next bag 20 from the supply of collection bags in inner housing 18 is pulled through central passage 21, allowing for a continuous stream of bags 20 to be deployed (e.g., as shown in FIG. 16) for use until the supply of bags 20 is empty. In the present embodiment, the supply of waste collection bags 20 is provided with perforations 20c along selective length portions of the supply to permit individual bags 20 to be ripped off (e.g., cut) at the perforations from the supply.

As described above, portable waste collection device 10 includes handle 14 connected to collection section 12 to facilitate placement of collection section 12 beneath the animal's or individual's derriere while defecating. According to another feature of the present invention, collection section 12 is configured to be used without handle 14. Specifically, connection assembly 25, including tubular connector 25a, can serve as a holding section configured to be held by the user when placing collection section 12 beneath the animal's or individual's derriere while defecating. As such, it will be appreciated that waste collection device 10 is particularly configured for use with or without handle 14 to accomplish the waste collection functions described herein.

By the foregoing construction and corresponding functions, it will be appreciated that waste collection device 10 exhibits improved portability. This facilitates carrying of the device by the user while walking the animal, such as dogs and other pets. The portable nature of collection device 10 also facilitates placement of collection section 12 under the animal's derriere to collect waste as described above. Similarly, the portable nature of waste collection device 10 also facilitates placement of collection section 12 under an individual's derriere, such as children during the potty-training stage and elderly individuals with poor mobility, to collect waste as describe above.

Waste collection device 10 is also easy to assemble and operate by virtue of its design and construction. The supply of waste collection bags 20 can be conveniently stored in annular inner housing 18 of collection device 10, and the concentric and spaced-apart inner 16a and outer 16b annular members forming annular inner housing 18, including central passage 21, permits each bag 20 to be pulled off from the supply of bags and reload a new bag for use to collect waste after the previous bag containing waste has been removed as described above.

In the preferred embodiment, waste collection device 10, including collection section 12, cover 22 and handle 14, is made of suitable lightweight, durable plastic materials. For example, the foregoing components of waste collection device 10 are made from high-density polyethylene (HDPE). HDPE is a durable, non-reactive thermoplastic that resists impact and inhospitable climates during use, transit or storage. It is understood that other suitable lightweight, durable materials can be used for collection device 10 without departing from the scope of the present invention.

According to another feature of the present invention, collection section 12 is made from a single, unitary piece of material. For example, collection section 12 can be molded in one piece by a suitable injection molding process. Similarly, cover 22 can also be made from a single piece of material by a suitable injection molding process.

With respect to the above description, the optimum dimensional relationships for the parts of the present waste collection device 10 include variations in size, materials, shape, form, function and the manner of operation, assembly and use which are deemed readily apparent to one skilled in the art, and all equivalent relationships to those illustrated in the drawings and described in the specification are intended to be encompassed by the present invention.

The portable waste collection device according to the present invention is simple, economical, and easy to make and operate to catch and hold animal waste, such as dog droppings excreted while walking the dog. It is carried by the dog's owner or caretaker while he or she takes the dog for a walk and is capable of collecting the dog's waste before it falls on the ground or grass. Since it is the dog's owner or caretaker's responsibility to pick up the dog's waste in public places, the waste collection device according to the present invention provides a very efficient, convenient, and sanitary way of collecting the waste while walking the dog.

The waste collection device of the present invention is also particularly suitable for collection of human waste to collect feces during the defecation process. For example, in the embodiment described herein, waste collection section 12 can be conveniently placed beneath the individual's derriere while defecating to collect expelled feces in the deployed bag of the waste collection device. This is particularly suitable for use with children during the potty-training stage, as well as with elderly individuals with poor mobility. This can be done by positioning waste collection section 12 during use by way of handle section 25, 25a or handle 14 as described above.

The embodiment of the portable waste collection device described herein and shown in the drawings includes a supply of waste collection bags 20 from which each bag is deployed during use of the device. In an alternative embodiment, the supply of waste collection bags is not provided as described above. Instead, the user can utilize individual bags during each use of the device to collect waste by attaching the bag to waste collection section 12 using any suitable removable connecting means, such as cable ties (e.g., zip ties), rubber bands, etc.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A portable waste collection device comprising: a waste collection section having an open end providing access into an annular inner housing configured to store and hold therein a supply of waste collection bags, and spaced-apart inner and outer annular members forming the annular inner housing therebetween, the inner housing having a base disposed opposite the top end and forming a bottom end of the waste collection section, and the inner annular member having a central passage extending through the waste collection section from the top end to the bottom end.

2. The portable waste collection section device of claim 1, wherein the waste collection section is made of a single, unitary piece of material.

3. The portable waste collection device of claim 2, wherein the material is high-density polyethylene (HDPE).

4. The portable waste collection device of claim 1, wherein the waste collection section is in the form of a cartridge configured to store the supply of waste collection bag while permitting individual bags to be continuously pulled out from the supply and through the central passage of the inner annular member.

5. The portable waste collection device of claim 1, wherein the waste collection section has a cover for removably covering the annular inner housing from the open end of the waste collection section.

6. The portable waste collection device of claim 5, wherein when connected to the waste collection device, the cover is further configured to securely retain the supply of waste collection bags within the annular inner housing.

7. The portable waste collection device of claim 6, wherein the cover is configured to be readily removed from the top end of the waste collection section to allow a new supply of waste collection bags to be accommodated within the annular inner housing.

8. The portable waste collection device of claim 1, wherein the supply of waste collection bags is provided with perforations at selected portions along the length of the supply to permit individual bags to be ripped off from the supply.

9. The portable waste collection device of claim 1, wherein the waste collection section is configured to be placed beneath an animal's or human's derriere during defecation to collect expelled feces using one of the bags deployed from the supply of waste collection bags.

10. The portable waste collection device of claim 9, further comprising a holding section connected to the collection section and configured to permit a user of the collection device to hold and position the waste collection section during use of the collection section to collect waste.

11. The portable waste collection device of claim 1, further comprising an elongated telescoping handle configured for removable connection to the waste collection section.

12. The portable waste collection device of claim 11, further comprising means for varying the angle between a longitudinal extension of the handle and the waste collection section to selectively adjust the position of the waste collection section during use of the collection device.

13. A portable animal waste collection device, comprising:
a waste collection section having an open end providing access into an annular inner housing configured to store and hold therein a supply of waste collection bags, a cover for removably covering the annular inner housing from the open end, and spaced-apart inner and outer annular members forming the annular inner housing therebetween, the inner housing having a base disposed opposite the top end and forming a bottom end of the waste collection section, and the inner annular member having a central passage extending through waste collection section from the top end to the bottom end; and
a handle configured for removable connection to the waste collection section for adjusting the position of the waste collection section during use of the portable animal waste collection device.

14. The portable animal waste collection device of claim 13, wherein the waste collection section is configured to be placed beneath an animal's derriere during defecation to collect expelled feces using one of the bags deployed from the supply of waste collection bags.

15. The portable animal waste collection device of claim 13, further comprising means for varying the angle between a longitudinal extension of the handle and the waste collection section to selectively adjust the position of the waste collection section during use of the collection device.

16. The portable animal waste collection section device of claim 13, wherein the waste collection section is made of a single, unitary piece of material.

17. The portable animal waste collection device of claim 13, wherein the waste collection section is in the form of a cartridge configured to store the supply of waste collection bag while permitting individual bags to be continuously pulled out from the supply and through the central passage of the inner annular member.

18. The portable animal waste collection device of claim 13, wherein when connected to the waste collection device, the cover is further configured to securely retain the supply of waste collection bags within the annular inner housing.

19. The portable animal waste collection device of claim 18, wherein the cover is further configured to be readily removed from the top end of the waste collection section to allow a new supply of waste collection bags to be accommodated within the annular inner housing.

20. The portable animal waste collection device of claim 13, wherein the supply of waste collection bags is provided with perforations at selected portions along the length of the supply to permit individual bags to be ripped off from the supply.
